(19) United States
(12) Patent Application Publication
(10) Pub. No.: US 2010/0220073 A1
(43) Pub. Date: Sep. 2, 2010

(54) ELECTRONIC DEVICE, CONTROL SYSTEM AND OPERATION METHOD THEREOF

(75) Inventor: Jui-Chien Wu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/714,558

(22) Filed: Mar. 1, 2010

(30) Foreign Application Priority Data
Mar. 2, 2009 (TW) 98106675

(51) Int. Cl. G06F 3/041; H04M 1/26; G06F 15/16

(52) U.S. Cl. 345/173; 379/355.03; 709/219; 455/564

(57) ABSTRACT

The invention provides an electronic device including a touch screen and a control system connected to the touch screen. The electronic device may display a digital image via a touch screen and sets at least an interaction region for the digital area. Each interaction region has corresponding interaction information recorded in a recognizing data. When a clicking even occurs on the touch screen, the control system determines whether the clicking position is in the interaction region. If the clicking position occurs in the interaction region, the control system retrieves the interaction data from the recognizing data and operates the electronic device according to the interaction information.

### CROSS-REFERENCE TO RELATED APPLICATION

This application claims the priority benefit of Taiwan application serial no. 98106675, filed on Mar. 2, 2009. The entirety of the above-mentioned patent application is hereby incorporated by reference herein and made a part of specification.

### BACKGROUND OF THE INVENTION

1. Field of the Invention

The invention relates to an electronic device and, more particularly, to an electronic device with an interaction function and an operation method thereof.

2. Description of the Related Art

With the rapid development of the information industry, information products are developed to be various electronic products with various functions such as personal computers, portable computer systems, mobile communication devices, personal digital assistants from the earlier computers acting as word and number processors. For these electronic devices increasingly popularized, a display screen or more than one external screens are used for users to operate. Digital images displayed by display screens become essential for various electronic devices.

An electronic device usually store many digital images for users to enjoy or use as a desktop to be displayed on the screen. In recent years, a digital photo frame is published, and it is an electronic device which may store and display a number of digital images.

However, most of the digital images mentioned above only may be browsed and enjoyed passively, and users usually cannot make any interaction such as making a phone call or connecting to a network with the electronic device via the digital images. For the usage of the digital images, the humanized and intuitive operation and management emphasized in the information field cannot be realized.

### BRIEF SUMMARY OF THE INVENTION

The invention provides an electronic device including a touch screen and a control system to allow a user to operate the electronic device via clicking the digital image displayed on the touch screen. Thus, an interaction effect may be achieved, and the use and management value of the digital images in the electronic device is increased.

The invention also provides an operating method adapted for the electronic device and the control system.

The invention provides an electronic device including a touch screen and a control system. The touch screen is used to display digital images, and the digital image has embedded recognizing data and has at least an interaction region. The interaction region has corresponding interaction information recorded in the recognizing data. The control system is coupled to the touch screen. When the digital image is displayed on the touch screen, and a clicking event occurs at a position on the digital image via the touch screen. The control system determines whether the position is in the interaction region. When the control system confirms that the position is in the interaction region, it retrieves the interaction information from the recognizing data and operates the electronic device according to the operation information.

The invention further provides a control system adapted for an electronic device having a touch screen for displaying digital images. The control system includes an recognizing module, a retrieving module and an operation module. When the digital image is displayed on the touch screen, and a clicking event occurs at a position on the digital image via the touch screen, the recognizing module determines whether the position is in an interaction region on the digital image. The interaction region has corresponding interaction information recorded in recognizing data embedded in the digital image. The retrieving module is coupled to the recognizing module, and it retrieves the interaction information from the recognizing data when the recognizing module confirms that the position is in the interaction region. The operation module is coupled to the retrieving module, and it receives the interaction data and operates the electronic device according to the interaction information.

In one embodiment of the invention, the electronic device may be a digital photo frame, a portable communication device, a personal digital assistant or a portable computer system.

In one embodiment of the invention, the electronic device further includes a telephone module coupled to the control system and connected to the telephone switching system. Thus, when the control system determines that the clicking event occurs in the interaction region, it may operate the telephone module to dial the telephone number. In addition, the telephone module is connected the telephone switching system via at least one of a telephone cable and a cellular wireless network.

In one embodiment of the invention, the electronic device also may include a network module which may be coupled to the control system and connected to the Internet. When the control system determines that the clicking event occurs in the interaction region, it may operate the network module to be connected to a remote server according to a uniform resource identifier (URI). In addition, the network module is connected to the remote server via one of a wired network and a wireless network. The network module also may be regarded as an extension of the telephone module. For example, a user may dial Skype phone or other VoIP phone via the network module.

In one embodiment of the invention, the interaction information includes one of a telephone number and a URI. The interaction information further includes a name of the interaction region.

In one embodiment of the invention, the recognizing data may be exchangeable image file format (EXIF) data.

The invention also provides an operating method for an electronic device. The method includes setting at least an interaction region on the digital image, editing the interaction information corresponding to the interaction region to recognizing data embedded in the digital image, and controlling the electronic device to display the digital image. Furthermore, in the method, when a clicking event occurs at a position in the digital image, whether the position is in the interaction region is determined. When the position where the clicking event occurs is determined to be in the interaction region, the electronic device may be operated according to interaction information (digital photo frame).

In one embodiment of the invention, wherein the step of determining whether the position is in the interaction region includes retrieving the coordinate information of the position and determining whether the coordinate information of the position where the clicking event occurs is in the interaction region to determine whether the position of the clicking event is in the interaction region.

In one embodiment of the invention, the step of editing the interaction information may include editing one of the telephone number and a URI to the recognizing data.

In one embodiment of the invention, wherein the step of operating the electronic device includes controlling the electronic device to dial the telephone number or operating the electronic device to connect to a remote server according to a URI.

According to the electronic device and the control system provided in the invention, the interaction region set in the digital image displayed on the touch screen of the electronic device may be clicked to retrieve the interaction information and drive the telephone module and network module in the electronic device. Thus, the interaction effect of dialing a telephone or connecting to a website may be generated.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing an electronic device in the embodiment of the invention;

FIG. 2 is a system block diagram showing the electronic device in the embodiment of the invention;

FIG. 3 is a flow chart showing an operation method for an electronic device in an embodiment of the invention; and

FIG. 4 is a schematic diagram showing the recognizing data.

### DETAILED DESCRIPTION OF THE EMBODIMENTS

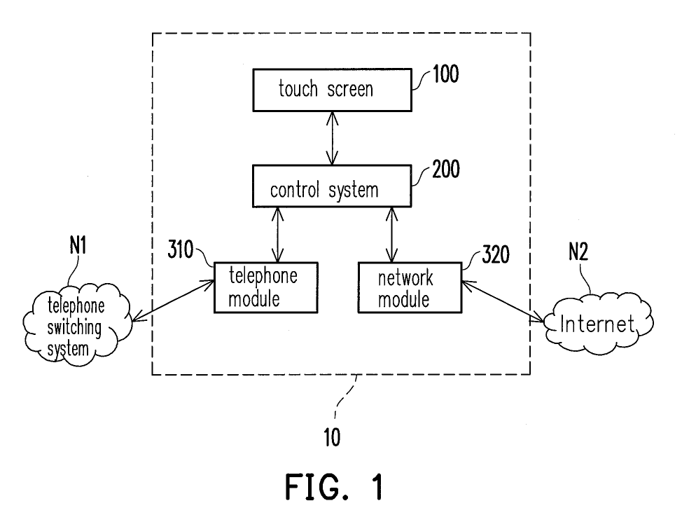

FIG. 1 is a schematic diagram showing an electronic device of an embodiment of the invention. As shown in FIG. 1, the electronic device 10 includes a touch screen 100 and a control system 200. The touch screen 100 may be used to display digital images, and it is coupled to the control system 200.

In some embodiments, the electronic device 10 may be an electronic device such as a digital photo frame, a mobile communication device, a personal digital assistant, a portable computer system or a personal computer. In addition, the touch screen 100 may be a touch control screen or liquid crystal display.

The electronic device 10 may include at least one of a telephone module 310 and a network module 320. In the embodiment, the telephone module 310 may be coupled to a telephone switching system N1 via a telephone cable or a cellular wireless network. Similarly, the network module 320 also may be connected to the Internet N2 via a wired network interface or a wireless network interface. The network module may be regarded as an extension of the telephone module. For example, a user may make a Skype phone call or a VoIP phone call via the network module.

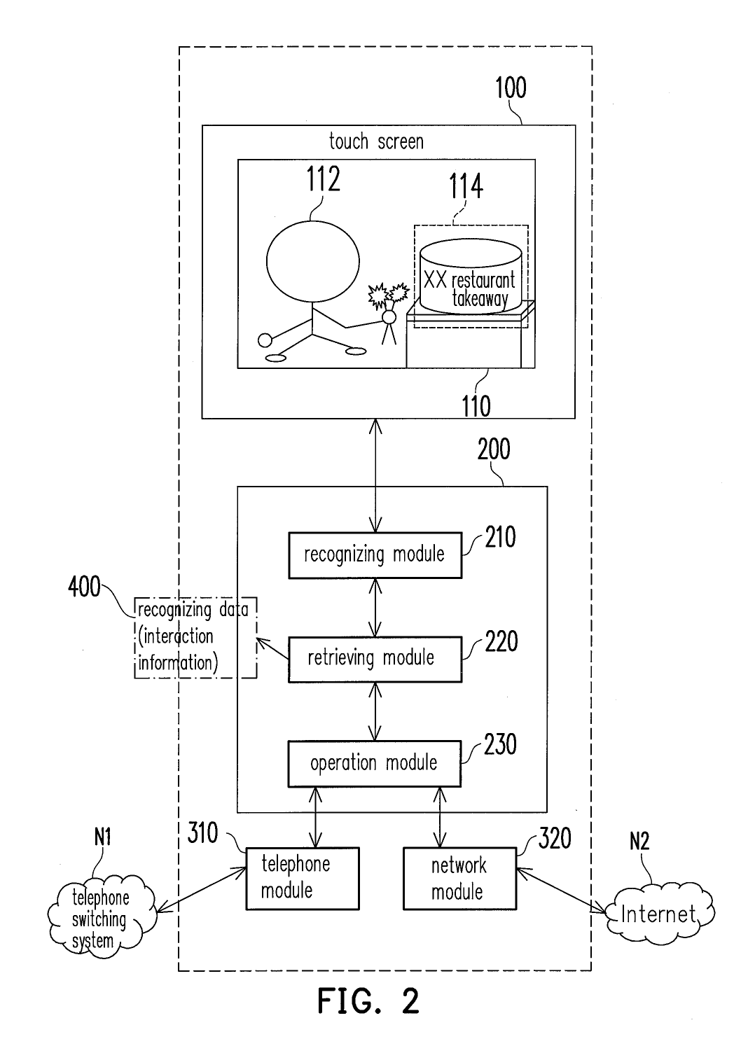

FIG. 2 is a system block diagram showing a control system in a preferred embodiment of the invention. As shown in FIG. 2, the control system 200 includes an recognizing module 210, a retrieving module 220 and an operation module 230. The recognizing module 210 is coupled to the touch screen 100 and is coupled to the retrieving module 220. The retrieving module 220 may retrieve recognizing data 400 embedded in the digital image 110. In the embodiment, the recognizing data 400 may be exchangeable image file format (EXIF) data, and it is usually embedded in a common digital image to record and add the property of the digital image and file format of the related data. The operation module 230 is coupled to the retrieving module 220, telephone module 310 and the network module 320. In some embodiments, the control system 200 may be realized via software, and the invention is not limited thereto.

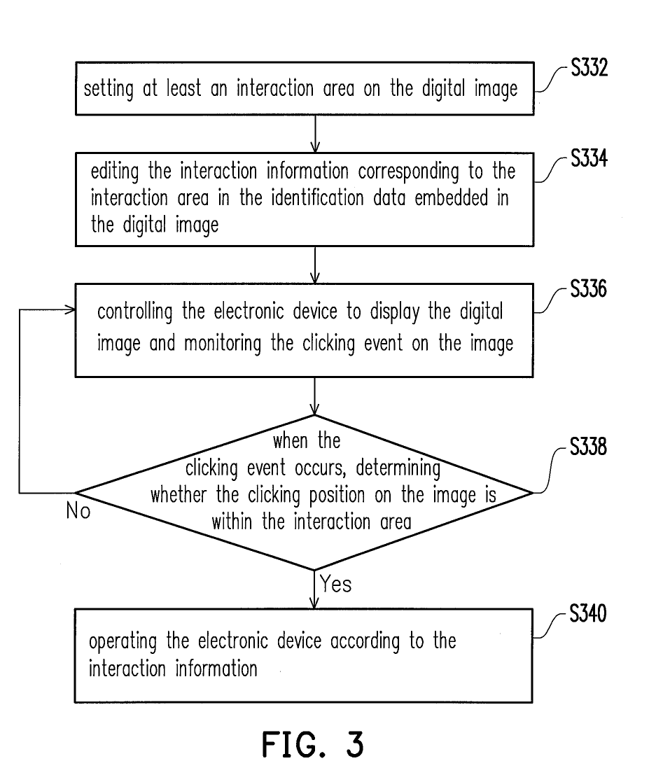

FIG. 3 is a flow chart showing the operation method for an electronic device in a preferred embodiment of the invention. As shown in FIG. 2 and FIG. 3, the touch screen 100 may display the digital image 110. The file format of the digital image 110 may be dot matrix, JPG or GIF. At least an interaction region may be set on the digital image 110, as stated in step S332. For example, the interaction regions 112 and 114 are set on the digital image 110.

In the embodiment, the way of setting the interaction region on the digital image may be utilizing image detecting software to detect a region of interest (ROI) on the digital image. For example, the human face in the digital image 110 is the interaction region 112. In addition, the image detecting software may record the coordinate range of the interaction region 112 to define the pixels on the touch screen 100 which belong to the interaction region 112.

In some embodiments, the way of setting the interaction region may be setting manually. For example, the user may frame a cylinder box marked with ┌xx restaurant take-away┘ and set it as the interaction region 114 in a frame selecting way. Any application may be used to capture the coordinate values of the interaction region. Therefore, the definition of the coordinates may be determined by the face test program or the used application, as long as the coordinate information may be provided to determine the inner and outer range of the interaction region 112.

As stated in step S334, the user may edit corresponding interaction information according to the position of the interaction region. In the embodiment, the interaction information may be edited in the recognizing data 400.

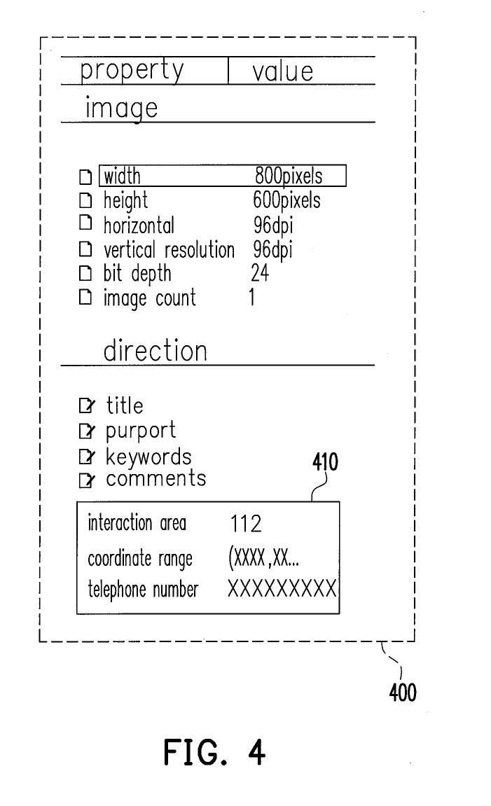

FIG. 4 is a schematic diagram showing recognizing data 400 (EXIF) embedded in the digital image 110 in a preferred embodiment of the invention. As shown in FIG. 4, the recognizing data 400 may record a plurality of data related to the digital image 110 such as the width, height or resolution of the digital image. Generally speaking, the recognizing data 400 still has a plurality of blank columns. The interaction data may be edited in these blank columns. For example, in the embodiment, the interaction information may be names of the interaction regions named by the users and the coordinate ranges of the interaction regions. In addition, the interaction information also may record at least one of a telephone number and a uniform resource identifier (URI) corresponding to each other.

The URI is a protocol essential element on the Internet, and any remote or local available resource may be positioned via the URI. These resources usually include HTML documents, icons, image files, program and so on. Thus, the position of the network resource in the Internet is marked with the URI. The URI may be further divided to uniform resource locator (URL) and uniform resource name (URN). Thus, the location or the name of the resource may be used to mark the resource on the network, respectively, to act as the guideline when the resource is accessed.

As shown in FIG. 2 and FIG. 3, the control system 200 controls the electronic device 10 to display the digital image 110 and monitors whether the clicking event on the digital image occurs, as stated in step S336. In the embodiment, the clicking event may be triggered by the user who touches any place on the digital image 110 via the touch screen 100.

When the clicking event occurs, the recognizing module 210 may perform step S338. That is, the recognizing module 210 determines whether the clicking event occurs in the interaction region 112 on the digital image 110 according to the coordinate range of each interaction region 112 retrieved from the recognizing data 400 by the retrieving module 220, and it may further determine whether the coordinate position of the clicking event stored in the temporary file in the last step falls in the coordinate range of the interaction region 112. If not, the flow path returns to the step S336. The recognizing module 210 of the control system 200 continues to monitor whether a clicking position occurs on the digital image 110 and monitor the clicking position. Relatively, if the recognizing module 210 confirms that the determining result is that the position where the selecting event occurs falls in one interaction region 112, the retrieving module 220 retrieves the corresponding interaction information to allow the operation module 230 to perform step S340. That is, the operation module 230 operates the electronic device 10 according to the interaction information.

Step S340 is illustrated hereinbelow with an example. Assuming that the recognizing module 210 detects that clicking event occurs in the interaction region, the retrieving module 220 retrieves the corresponding interaction information. Then, the operation module 230 controls the telephone module 310 to make a phone call via the telephone switching system N1 according to the telephone number “XXXXXXXXXX” recorded in the interaction information.

In another embodiment, assuming that a URI is recorded in the interaction information set for the interaction region 114. In the embodiment, the URI is represented by the “domain name”, especially a webpage representing xx restaurant. When the recognizing module 210 confirms that the clicking event occurs in the interaction region 114, the retrieving module 220 may retrieve corresponding interaction information, and the operation module 230 may control the network module 320 to be connected to a remote server via the Internet N2 to generate an interaction of starting the browser of the electronic device 10 and linking to the webpage of the xx restaurant. This embodiment may be used to, for example, order lunch for each workday.

The examples are various, and a user also may utilize touch screen 100 and the operating system 200 of the electronic device 10 to set information related to friends or tour sights in the digital image captured in the tour to further manage the information of the digital image. The information may be telephone number, Blog or related webpages.

To sum up, the electronic device and the operation method provided by the invention may allow the digital image stored in the electronic device which only may be enjoyed passively in the past to provide a human-machine interaction (HMI) function. Thus, many effects may be obtained. For example, the user may click the digital image to make a phone call or connect to a website, or the user may utilize a URI to access network resource in the Internet. Thus, in the information field, the operation may be more humanized and intuitive.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An electronic device comprising:
a touch screen displaying a digital image in which recognizing data is embedded, wherein the digital image includes at least an interaction region, and content of the recognizing data and the interaction region have corresponding interaction information; and
a control system coupled to the touch screen, wherein when the digital image is displayed on the touch screen, and a clicking event occurs at a position on the digital image via the touch screen, the control system determines whether the position is located in the interaction region, and when the control system confirms that the position occurs in the interaction region, the control system retrieves the interaction information from the recognizing data and operates the electronic device according to the interaction information.

2. The electronic device according to claim 1, wherein the interaction information comprises one of a telephone number and a uniform resource identifier (URI).

3. The electronic device according to claim 2, further comprising a telephone module coupled to the control system and used for being connected to a telephone switching system, wherein when the control system determines that the position is located in the interaction region, the control system operates the telephone module to dial the telephone number.

4. The electronic device according to claim 3, wherein the telephone module is connected to the telephone switching system via one of a telephone cable and a cellular wireless network.

5. The electronic device according to claim 2, further comprising a network module coupled to the control system and connected to the Internet to allow control system to operate the network module to connect to a remote server according to the URI when the control system determines that the position is located in the interaction region.

6. The electronic device according to claim 5, wherein the network module is connected to the Internet via at least one of a wired network and a wireless network.

7. The electronic device according to claim 2, wherein the interaction information further comprises the name of the interaction region.

8. The electronic device according to claim 1, wherein the recognizing data is exchangeable image file format (EXIF) data.

9. The electronic device according to claim 1, wherein the control system comprises a recognizing module, a retrieving module and an operation module, the retrieving module is connected to the recognizing module and the operation module, respectively, and when a clicking event occurs in the interaction region of the digital image, the retrieving module retrieves the interaction information, and the operation module operates the electronic device via the interaction information.

10. A control system adapted to an electronic device having a touch screen for displaying a digital image, the control system comprising:
a recognizing module, wherein when the digital image is displayed on the touch screen, and a clicking event occurs at a position on the digital image via the touch screen, the recognizing module determines whether the position is located in an interaction region on the digital image, and the interaction region has corresponding interaction information recorded in recognizing data embedded in the digital image;
a retrieving module coupled to the recognizing module, wherein when the recognizing module confirms that the position is located in the interaction region, the retrieving module retrieves the interaction data from the recognizing data; and
an operation module coupled to the retrieving module, receiving the interaction information and operating the electronic device according to the interaction information.

11. The control system according to claim 10, wherein the interaction information comprises one of a telephone number and a URI.

12. The control system according to claim 10, wherein the recognizing data is EXIF data.

13. The control system according to claim 10, wherein the electronic device comprises a digital photo frame, a portable communication device, a personal digital assistant and a portable computer system.

14. An operation method for an electronic device, comprising the steps of:
setting at least an interaction region on a digital image and editing interaction information corresponding to the interaction region into recognizing data embedded at the digital image;
displaying the digital image;
when a clicking event occurs on a position in the digital image, determining whether the position is in the interaction region; and
when the position is in the interaction region, operating the electronic device according to the interaction information.

15. The operation method according to claim 14, wherein the step of determining whether the position is in the interaction region comprises the steps of:
retrieving coordinate information of the position; and
determining whether the coordinate information of the position is in the range of the interaction region to determine whether the position is in the interaction region.

16. The operation method according to claim 14, wherein the step of editing the interaction information comprising editing one of a telephone number and a URI to the recognizing data.

17. The operation method according to claim 16, wherein the step of operating the electronic device comprises controlling the electronic device to dial the telephone number.

18. The operation method according to claim 16, wherein the step of operating the electronic device comprises operating the electronic device to be connected to a remove server according to the URI.

19. The operation method according to claim 16, wherein the step of editing the interaction information further comprises naming the interaction region.

20. The operation method according to claim 14, wherein the recognizing data is EXIF data.
